(19) United States
(12) Patent Application Publication
(10) Pub. No.: US 2005/0163688 A1
(43) Pub. Date: Jul. 28, 2005

(54) Process for removal of impurities from secondary alumina fines and alumina and/or fluorine containing material

(75) Inventors: Otto Morten Bade, Oslo (NO); Ivar Dahl, Oslo (NO)

Correspondence Address: WENDEROTH, LIND & PONACK, L.L.P., 2033 K STREET N. W., SUITE 800, WASHINGTON, DC, 20006-1021, US

(73) Assignee: ALSTOM (SWITZERLAND) LTD., Baden (CH)

(21) Appl. No.: 10/499,034

(22) PCT Filed: Dec. 17, 2002
(86) PCT No.: PCT/NO02/00485

(30) Foreign Application Priority Data
Dec. 19, 2001 (NO) 2001 6230

(51) Int. Cl. C01F 3/00

(52) U.S. Cl. 423/111

(57) ABSTRACT

The invention relates to a process for removal of impurities from secondary aluminia fines and alumina and or fluorine containing material comprising. (a) acidification by adding an acid (2,12,32) to the material to be purified (1,11,31); (b) heading the acidified mixture (3,13,35); (c) leaching the mixture in a solution of an acid (6,16,39); (d) separating the solid and liquid.

### BACKGROUND

In the process for electrolytic production of aluminium, such as the Hall-Heroult process where aluminium is produced by reducing alumina (aluminium oxide, Al₂O₃) in a melted electrolyte in the form of a fluorine-containing mineral to which alumina is fed, the process gases are loaded with fluorine-containing substances, such as hydrogen fluoride and fluorine-containing dust. Being extremely damaging to the environment, these substances have to be separated before the process gases can be discharged into the surrounding atmosphere. At the same time the fluorine-containing melt is essential to the electrolytic process.

Dry scrubbing is often used to clean gas and dust emitted from electrolysis cells in the production of aluminium. By utilising smelter grade alumina (primary alumina) as scrubbing medium (adsorbent), fluorine-containing gases, as well as fumes and dust are collected in the dry scrubber filter. The collected material (secondary alumina) is then used in the production of aluminium, hence the emitted gaseous fluorine and particulate fluorine compounds are recycled.

The recovery of fluorine-containing compounds from gases generated during aluminium production suffers from the inconvenience that the process gas is usually loaded also with other substances considered as unwanted impurities. These impurities have limited solubility in the aluminium metal and hence accumulate in the cell and dry scrubber system during collection and recycling. The impurities enter the dry scrubber as condensed cell volatiles and entrained bath particles, and become a fraction of the secondary alumina, which is fed back to the electrolytic process. Compounds of transition metals, phosphorous, carbon and some other elements are among the substances considered as unwanted impurities due to their negative effect on the electrolytic process and on metal quality. Accumulation of sodium will shift the composition of the electrolysis bath. In order to regenerate the desired composition, some electrolysis bath must be removed and replaced with bath components with less sodium. This removed bath is called “excess bath”, and represents a material which has to be disposed off. Sodium may thus also be considered as unwanted, since more sodium implies more “excess bath”.

The impurities originate from the consumption of anodes but also from impurities found in the raw material, and should be removed from the secondary alumina before this is recycled to the process.

It is possible to reduce the amount of impurities in this recirculation loop by removing fumes and dust with dust collecting devices in the pot gas duct upstream the dry scrubber as described by Boehm et al. “Removal of Impurities in Aluminium Smelter Dry Gas using the VAW/Lurgi Process”, Light Metals (1976) Vol 2 pp 509-521 and L. C. B Martins “Use of Dry Scrubber Cyclone to improve the purity of Al” Light Metals (1987) pp 315-317.

Another option is to remove impurities from the secondary alumina stream on its way to the cell. The latter can be done by capture of the fine particulate fraction from the bulk alumina stream, since the impurities are highly enriched in the finest fraction of secondary alumina (secondary alumina fines).

A process for separation of the finest fraction from the bulk secondary alumina stream is disclosed by Beckman in U.S. Pat. No. 4,525,181. This patent discloses a process for separation of fine dust containing impurities from alumina, consisting of
(a) a disintegrating step, where the secondary alumina is blown against a substantially transverse impinging surface to disintegrate the fines containing the impurities from the alumina crystals,
(b) a separating step, where the dust or finely divided sublimate particles are selectively separated from the alumina crystals.

An alternative process for separation of the finest fraction from the bulk secondary alumina stream is disclosed by Schuh and Jansen in WO 96/20131 (DE 195 44 887 A1). In this process, the alumina powder is projected at a predetermined speed and frequency against at least one surface in order to separate therefrom particles of impurities that adhere to the surface of the powders. The powders are then sorted according to size.

The capture of this fine particulate material, either from the pot gas stream or from the secondary alumina stream, yields a waste product of secondary alumina enriched in impurities and fluorine-compounds. In practical applications, the loss of alumina and fluorine-compounds may be considerable. A fines fraction of 2 wt % amounts to 40 kg per ton aluminium produced. If purified, alumina and/or fluorine-compounds could be recovered economically from the fines, this would make the simple fines separation (according to U.S. Pat. No. 4,525,181 and WO 96/20131) more attractive proposals.

With the intention to recover valuable fractions, thermal treatment, physical separation techniques and different wet chemical methods have been studied and are reported in the literature.

Thermal treatment: GB 1479924 by Winkhaus et al, recovers HF from a separated fine fraction of used adsorbent, e.g. fluorine and impurity enriched alumina, by pyrohydrolysis at T>500° C. This is a well known method for HF formation. The produced HF can be guided back to the dry scrubber plant or reacted to valuable fluorine-containing products such as AlF₃.

Generally it is well known that carbon in contaminated samples may be oxidised in air or an oxygen rich atmosphere at elevated temperatures, typically above 500° C. Since impurities such as phosphorous and iron compounds have low volatility, these compounds remain in the solid fraction and hence recovery of pure alumina is rather difficult with the thermal method.

Physical separation: Lossius and Øye present in “Removing Impurities from Secondary Alumina Fines”, Light Metals (1992) pp 249-258, that the app. 2 wt % finest fraction of secondary alumina contains 10% of the fluorine compounds and 50% of the contaminants. Physical separation techniques include ultrasonic vibration of water slurries, wet and dry magnetic separation, flotation and stratification by settling. The aim is to separate a valuable fraction of the fluorine enriched alumina fines. Lossius and Øye concluded that wet magnetic separation of these partly deagglomerated fines is an efficient way of separating the impurities P, S, Ti, V, Fe and Ni from the process stream without sacrificing F reclamation or loss of Al₂O₃. However this process has not proven to be valuable on industrial scale.

Wet chemical methods: Wet chemical methods include dissolution of fluorine-compounds in both basic and acidic solutions. The dissolved fluorine-compounds may then be recovered as AlF₃ or cryolite. According to Lossius and Øye in “Removing Impurities from Secondary Alumina Fines”, Light Metals (1992) pp 249-258, some of the impurities are only slightly soluble in water, basic or acidic solutions.

Accordingly, the remaining undissolved residue (e.g. the alumina fraction in the case of alumina fines treatment) will still be contaminated. U.S. Pat. No. 5,558,847 by Kaaber et al discloses a process for recovering aluminium and fluorine from “Fluorine Containing Waste Materials” (FCWM). FCWM is leached with dilute sulphuric acid, at pH 0-3, if necessary with aluminium in acid soluble form. pH is adjusted to 3,7-4,1 by aqueous NaOH to precipitate silica at T<60° C. The mixture is separated to a solid phase containing precipitated silica and non-soluble residues and a purified solution. The precipitate of AlF₂OH hydrate is calcined at 500-600° C. to give AlF₃ and Al₂O₃, which are recycled back to the electrolysis cells.

U.S. Pat. No. 6,187,275 by Barnett and Mezner, discloses a method for recovering AlF₃ from spent potliner (SPL) by using an acid digest to form gaseous HF which is converted to hydrofluoric acid and reacted with alumina trihydrate to form AlF₃. In the process, spent potliner material is introduced onto an acid digester containing, for example, sulphuric acid. As a result, a gas component is produced which includes hydrogen fluoride and hydrogen cyanide. Also, a slurry component is produced which includes carbon, silica, alumina, sodium compounds such as sodium sulphate, aluminium compounds such as aluminium sulphate, iron compound such as iron sulphate, magnesium and calcium compounds such as magnesium and calcium sulphate. The slurry component remains in the digester after the gas component is removed. The gas component is recovered and heated an effective amount to convert or decompose the hydrogen cyanide to a remaining gas component including CO₂, H₂O, nitrogen oxides as well as HF. The remaining gas component is directed through a water scrubber in which HF is converted to liquid hydrofluoric acid, which is further reacted to useful end products. The slurry is rinsed and may be used as fuel in cement or glass manufacturing, or may be subjected to elevated temperature in an oxygen-rich atmosphere, which causes carbon to oxidise to carbon dioxide, leaving a refractory material such as mullite formed from silica and alumina which has commercial utility in forming bricks.

It is one object of the present invention to provide a process for treating secondary alumina fines from fume treatment systems in aluminium production facilities, in order to remove contaminants from said alumina.

It is another object of the present invention to recover valuables from the alumina, that is alumina and fluorides, while the impurities are deposited.

The process is described mainly with reference to treating alumina fines, however, it is assumed that the process may be used on material collected in pot gas dust collecting devices, “excess bath” and/or any other fluorine or alumina containing material occurring in aluminium production.

### SUMMARY OF THE INVENTION

The present invention relates to a combined chemical and thermal process for purification of contaminated secondary alumina fines or any other sodium-alumina-fluorine containing material related to aluminium production. Alumina and aluminium fluoride are to a high extent recovered, while impurities such as compounds of phosphorous, iron, titanium, vanadium, nickel, carbon, sulphur, sodium, etc. to a high extent are removed.

The invention is disclosed with basis in the non-limiting detailed description and examples. However, the patent is intended to cover all possible variations and adjustments within the scope and spirit of the invention as disclosed in the appended claims.

The present invention relates to a process for removal of impurities from secondary alumina fines and alumina and/or fluorine containing material wherein the process comprises:
(a) acidification of the material to be purified (1, 11, 31) by adding an acid (2, 12, 32);
(b) heating the acidified mixture (3, 13, 35);
(c) leaching the mixture in a solution of an acid (6, 16, 39);
(d) separating the solid and liquid.

In one embodiment of the invention, the gas evolved in step (a) and (b) is collected and guided to a dry scrubber, in order to recover the fluorine-compounds.

The acid utilized in the process may be neat or aqueous. The process may be conducted in a batchwise or continuous mode.

In another embodiment, the material to be purified is mixed with the aqueous acid between the steps (a) and (b).

In a further embodiment, the acidified material is pre-dried before the heat treatment (b).

The material separated in step (d) may be dried in a conventional dryer.

The acid in step (a) may be a strong acid, preferably a strong inorganic acid, most preferably sulphuric acid. The molar ratio of H⁺ from the acid to F-content in the material may be from 0,2 to 10 more preferably 0,4 to 4, most preferably 0,6 to 2. The volume of acid or aqueous acid (2, 12, 32) in step (a) may in total be from 10 to 1000 ml per 100 g alumina, preferably from 20 to 200 ml per 100 g alumina, most preferably from 30 to 100 ml per 100 g alumina.

In another embodiment the material before the acid leaching step (38) is crushed in a crusher (D3).

The solids before the drying step (23, 46) may be washed in order to remove rest acid. The washing liquor (20, 43) is water, lower alcohol e.g. methanol, ethanol, or an alkali solution, e.g. ammonia.

In a further embodiment, the residence time in the heat treatment (B1, B2, C3) is at least 2 minutes, preferably at least 5 minutes, most preferably at least 10 minutes. The temperature in the heat treatment (B1, B2, C3) may be from 100 to 1000° C., preferably from 300 to 800° C., most preferably 400 to 700° C.

In a further embodiment, the residence time in the acid leaching step (C1, C2, E3) is at least 5 minutes, preferably at least 15 minutes, most preferably at least 30 minutes.

In an even further embodiment the residence time in the washing step (E2, G3) for removal of rest acid is at least 2 minutes, preferably at least 5 minutes, most preferably at least 10 minutes. The temperature in the acid leach (C1, C2, E3) and washing step (E2, G3) for removal of rest acid may be in the range 20-150° C., preferably 60-95° C.

The scope of the invention shall be considered to be covered by the appended independent claim.

### BRIEF DESCRIPTION OF THE FIGURES

Some non-limiting embodiments of the invention are shown in the figures wherein:

FIG. 1 shows a schematic flow diagram of the simplest embodiment of the process according to the invention.

FIG. 2 shows a schematic flow diagram of one preferred embodiment of the process according to the invention.

FIG. 3 shows a schematic flow diagram of another preferred embodiment of the process according to the invention.

### DETAILED DESCRIPTION OF THE INVENTION

The present invention relates to a combined chemical and thermal process for purification of contaminated secondary alumina or other sodium-aluminium-fluorine containing materials. Alumina and aluminium fluoride are to a high extent recovered, while impurities such as compounds of phosphorous, iron, titanium, vanadium, nickel, carbon, sulphur, sodium, etc. to a high extent are removed.

As mentioned above, heat treatment of fluorine-enriched alumina fines in air to above 500° C. releases carbon as CO₂. Depending on temperature and residence time, parts of the fluorine compounds may be released as HF gas.

It was observed that addition of an aqueous acid solution (2, 12, 32) to the fluorine-enriched alumina fines prior to heat treatment in air caused release of C and some F (i.e. more than 25 wt-%) (4, 14, 36) during the heat treatment step (B1, B2, C3); this is similar to heating in air only. The volume of aqueous acid is not necessarily large, moistening of the material to be purified is sufficient.

The acid- and heat-treated sample (5, 15, 38) is then brought to an acid leaching step (C1, C2, E3) containing a concentrated solution of a strong acid (6, 16, 39), preferably a strong inorganic acid, e.g. hydrochloric acid or sulphuric acid, preferably sulphuric acid. Surprisingly, it was observed that the phosphorous, sodium and transition metals such as Fe, Ni, Ti and V to a high extent were leached into the solution, while only a small leach of F was detected. The solid material recovered from the acid leaching step (19, 42) was washed with a washing solution (20, 43) and dried (G2, 13). Analysis showed that a substantial part of all elements other than Al, O, F and S were removed, compared with the initial concentrations. When using sulphuric acid, sulphur in the sample is mainly remaining sulphuric acid, and its concentration is depending on the duration of the washing step to remove remaining acid. Since sodium is removed, the former cryolite and chiolite must have reacted to acid-insoluble aluminium fluoride compounds.

This observation is unexpected, since similar leaching experiments of non acid- and heat treated samples yields a solution with dissolved fluorides, where the solid alumina fines are still contaminated with impurities, e.g. P and transition metals.

The novelty of the process is the reaction of insoluble impurities (Fe, P, V, Ni, Ti, etc.) to acid soluble species, while the F-compounds which previously were acid soluble, are reacted to non-soluble aluminium-fluoride complexes. The process, consisting of acidification, heat treatment and leaching with acid solution, represents a new method for treating of contaminated fluorine-enriched alumina fines and other alumina containing materials. The result of the combination of these steps could not be expected on the basis of known technology.

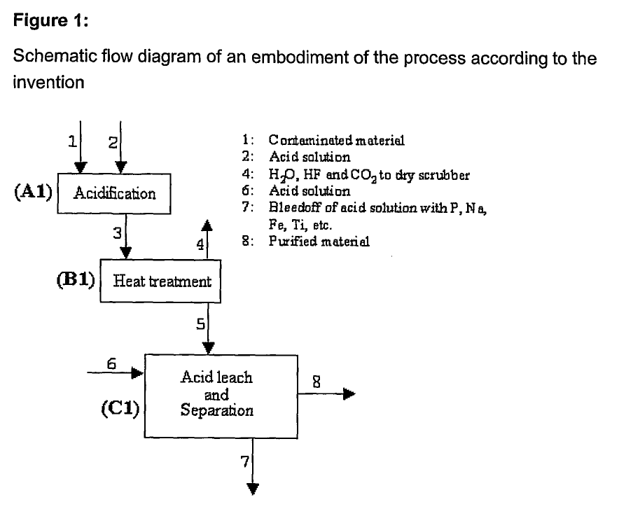

The simplest embodiment of the invention is disclosed in FIG. 1 wherein an aqueous acid solution (2) is added to the material to be purified (1) before this enters the heat treatment, from where it is passed to an acid leaching and separation step (C1) to achieve purified material (8).

In this most basic form, the process according to the invention consists of the following main steps as shown in FIG. 1.

i. Acidification (Al): The material which is to be purified (1), is wetted with an aqueous solution of a strong acid (2), most preferably sulphuric acid.

The material is wetted to a clay-like paste (3). The molar ratio of acid to F-content in the material is, when sulphuric acid is utilized, in the range from 0,1 to 5, more preferably 0,2 to 2, most preferably 0,3 to 1. If a monoprotic acid is utilized, all the figures given above must be doubled. The amount of aqueous acid solution is from 10 to 1000 ml per 100 g material, preferably from 20 to 200 ml per 100 g material, most preferably from 30 to 100 ml per 100 g material. As an alternative, it may be possible to use a neat acid, which is not in aqueous solution.

ii. Heat treatment (B1): The wetted material (3) is heated to a high temperature in a furnace (B1), preferably in the range 100-1000° C., more preferably 300-800° C., most preferably 400-700° C. The reaction time is typically at least 2 minutes, more preferably at least 5 minutes, most preferably at least 10 minutes. Carbon is preferably oxidised to CO₂, and some of the fluorides in the sample are emitted as HF gas (4) which is guided back to the dry scrubber. The amount of HF released in this step is not critical.

iii. Acid leaching and separation step (C1): The heat-treated material (5) is treated with a solution of a strong acid (6), preferably a strong inorganic acid, e.g. hydrochloric acid or sulphuric acid, most preferably sulphuric acid, for at least 5 minutes, more preferably at least 15 minutes, most preferably at least 30 minutes at elevated temperature in the range 20 to 150° C. The impurities, consisting of elements of e.g. phosphorous, sodium and transition metals, are leached into solution, while alumina and aluminium fluorides mainly remain as a solid fraction. The liquid (7) and solid (8) phases are separated by a conventional separation method, e.g. gravity, centrifugation or filtration.

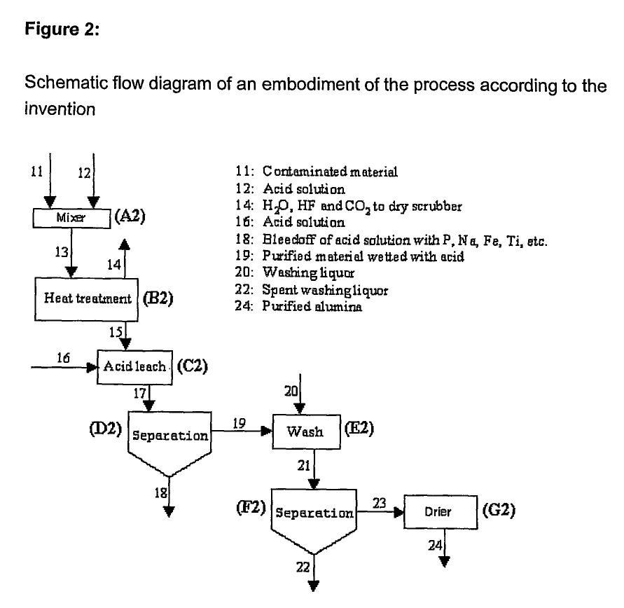

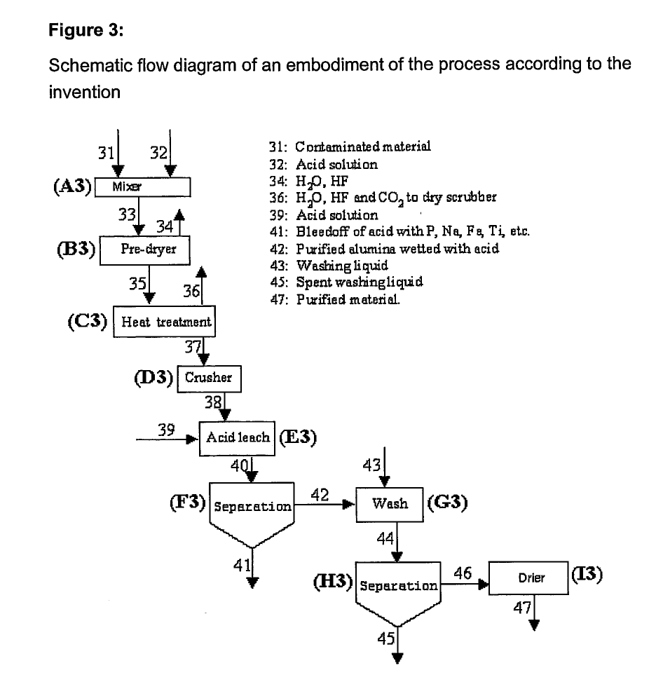

Alternative embodiments are disclosed in the FIGS. 2 and 3 wherein

FIG. 2 shows a schematic flow diagram of one preferred embodiment of the process according to the invention. The material to be purified (11) is mixed with an aqueous acid solution (12) prior to passing into the heat treatment (B2), from where it is passed to an acid leaching step (C2) followed by separation of purified material (19) which is washed to remove remaining acid, separated and dried.

FIG. 3 shows a schematic flow diagram of another preferred embodiment of the process according to the invention. The material to be purified (31) is mixed with an aqueous acid solution (32) prior to pre-drying and passing into the heat treatment (C3), upon leaving the heat treatment, it is crushed (D3) and passed to an acid leaching step (E3) followed by separation of purified material (42) which is washed to remove remaining acid, separated and dried.

The alternative embodiements as seen in the FIGS. 2 and 3, comprise the following additional steps, the numerals refer to FIG. 3:

ia. Mixing (A3): The acidification may take place in a mixer.

iia. Pre-drying (B3): The acidified material (33) may be pre-dried by heating in a conventional heating device (B3) prior to the heat treating ii in order to remove some of the water (34).

iiia. Crushing (D3): The heated paste (37) turns into a hard material which may be crushed in a conventional crushing device (D3) prior to the acid leaching step. The crusher may be integrated in the heat treatment (C3) or between pre-drying and heat treatment.

iv. Washing (G3): The solid material (42) may be washed in a polar liquid (43), e.g. water, alcohol e.g. methanol, ethanol, or an alkali solution, e.g. an ammonia solution in order to remove remaining acid from the acid leaching step. The residence time in the washing step (G3) is at least 2 minutes, preferably more than 10 minutes.

v. Separation (H3): The liquid (45) and solid (46) phases are separated in a conventional separation device (H3), e.g. by gravity, centrifugation or filtration.

vi. Drying of the purified material (13): The purified material (46) is dried in a conventional dryer (13) or by utilising heat present in the dry scrubber system, before the material is returned to the electrolytic cell for aluminium production.

The waste product (7, 18, 41) is a bleed-off consisting of an impurity containing acid solution used for the leaching step, which has to be neutralised and deposited of.

The process may be conducted in a batchwise or in a continues mode. The process according to the invention is mainly developed for treating contaminated secondary alumina fines or pot fumes and dust captured from the pot gas, but is also suitable for treating of bath material skimmed off during anode change, “excess bath” and any other fluorine and/or alumina containing material occurring in aluminium production.

### EXAMPLES

Embodiments of the invention will be further described by way of the following illustrating but non-limiting examples.

### Example 1

### Treatment of Alumina Fines

100 g Secondary alumina fines from the process described in WO 96/20131 (DE 195 44 887 A1) was wetted with an aqueous solution of 50 ml 40 wt % H₂SO₄. The resulting “paste” was heated to 600° C. for 15 minutes in air in a furnace. The sample was then crushed and suspended in a 30 wt % sulphuric acid solution for one hour at 90° C. After this leaching step, the solids were separated from the liquor by using a centrifuge. The sample was then washed in pure hot water (90° C.) for another 15 minutes, and finally dried.

The following Tables 1 and 2 show the elemental composition (in % and g) of the alumina fines sample as received, the sample after the pre-acidification and heat treatment step, and of the final purified material

TABLE 1
Elemental composition (in wt %) of the alumina fines sample as received, of the sample after the acidification and
heat treatment step, and of the purified alumina produced:

| | weight | Al | O | C | F | Na | S | Ca | K | Fe | Si | P | Ni | Cu | V | Pb | Ti | Ga | As |
|---|---|---|---|---|---|---|---|---|---|---|---|---|---|---|---|---|---|---|---|
| | (g) | (%) | (%) | (%) | (%) | (%) | (%) | (%) | (%) | (%) | (%) | (%) | (%) | (%) | (%) | (%) | (%) | (%) | (%) |
| alumina | 100 | 46 | 35 | 2 | 10.2 | 4.2 | 1.17 | 0.14 | 0.33 | 0.45 | 0.03 | 0.04 | 0.21 | 0.022 | 0.017 | 0.032 | 0.006 | 0.04 | 0.009 |
| fines as | | | | | | | | | | | | | | | | | | | |
| received | | | | | | | | | | | | | | | | | | | |
| after | 102 | 42 | 41 | 0 | 5.5 | 3.4 | 7.5 | 0.13 | 0.34 | 0.44 | 0.11 | 0.037 | 0.2 | 0.02 | 0.017 | 0.026 | 0.006 | 0.04 | 0.01 |
| acidifi- | | | | | | | | | | | | | | | | | | | |
| cation | | | | | | | | | | | | | | | | | | | |
| and heat | | | | | | | | | | | | | | | | | | | |
| treatment | | | | | | | | | | | | | | | | | | | |
| after acid | 73 | 51 | 40 | 0 | 6.3 | 0.58 | 1.6 | 0.017 | 0.024 | 0.09 | 0.08 | 0.009 | 0.042 | 0.003 | 0.006 | 0.02 | 0.002 | N.D. | 0.016 |
| leach and | | | | | | | | | | | | | | | | | | | |
| water | | | | | | | | | | | | | | | | | | | |
| wash | | | | | | | | | | | | | | | | | | | |

TABLE 2
Elemental composition (in total weight) of the alumina fines sample as received, of the sample
after the acidification and heat treatment step, and of the purified alumina produced:

| | weight | Al | O | C | F | Na | S | Ca | K | Fe | Si | P | Ni | Cu | V | Pb | Ti | Ga | As |
|---|---|---|---|---|---|---|---|---|---|---|---|---|---|---|---|---|---|---|---|
| | (g) | (g) | (g) | (g) | (g) | (g) | (g) | (g) | (g) | (g) | (g) | (g) | (g) | (g) | (g) | (g) | (g) | (g) | (g) |
| alumina fines | 100 | 46 | 35 | 2 | 10.2 | 4.2 | 1.17 | 0.14 | 0.33 | 0.45 | 0.03 | 0.04 | 0.21 | 0.022 | 0.017 | 0.032 | 0.006 | 0.04 | 0.009 |
| as received | | | | | | | | | | | | | | | | | | | |
| after | 102 | 43 | 42 | 0 | 5.6 | 3.5 | 7.7 | 0.13 | 0.35 | 0.45 | 0.11 | 0.037 | 0.2 | 0.02 | 0.017 | 0.027 | 0.006 | 0.04 | 0.01 |
| acidification and | | | | | | | | | | | | | | | | | | | |
| heat treatment | | | | | | | | | | | | | | | | | | | |
| after acid leach | 73 | 37 | 29 | 0 | 4.6 | 0.42 | 1.2 | 0.012 | 0.018 | 0.07 | 0.06 | 0.007 | 0.03 | 0.002 | 0.004 | 0.015 | 0.001 | N.D. | 0.012 |
| and water wash | | | | | | | | | | | | | | | | | | | |

As can been seen from the 2. column in Table 1, the recovered solid fraction constitutes 73% of the initial mass. Approximately 45% of the initial amount of fluorides is released through the heat treatment, while another approximately 45% is recovered with the purified alumina fines. The silicon content in the material during processing is increased due to carry over from the porcelain crucible used in the experiment.

Similar experiments have been performed on the pot fumes removed from Søderberg cell gas by electrostatic precipitators. Results from these experiments show much of the same tendencies as illustrated in the example above, but the release of fluorine in the heating step is higher.

### Example 2

### Treatment of Fumes from Søderberg Pot Gas Separated by Electrostatic Precipitators

100 g fumes separated by electrostatic precipitators from pot gas on a typical Søderberg plant in Norway was moistened with an aqueous solution of 50 ml 15 wt % H₂SO₄. The resulting “paste” was heated to 600° C. for 15 minutes in air in a furnace. The sample was then crushed and suspended in a 30 wt % sulphuric acid solution for one hour at 90° C. After this leaching step, the solid sample was separated from the liquor by using a centrifuge. The sample was then washed in pure hot water (90° C.) for another 15 minutes, and finally dried.

The following Table 3 shows the elemental composition of the pot fumes as received, the sample after the acidification and heat treatment step, and of the final purified material.

### Example 3

### Treatment of Alumina Fines; Comparison with Treatment without Acidification Step

100 g Secondary alumina fines from the process described in WO 96/20131 (DE 195 44 887 A1) was heated to 600° C. for 30 minutes in air in a furnace. The sample was then suspended in a 30 wt % sulphuric acid solution for one hour at 90° C. After this leaching step, the solid sample was separated from the liquor by using a centrifuge. The sample was then washed in pure hot water (90° C.) for another 15 minutes, and finally dried.

The following Table 4 shows the elemental composition (in % and g) of the alumina fines sample as received, the sample after heat treatment, and of the final material produced.

As can be seen from table 4, this method, i.e. without acidification of the material prior to heat treatment, gave only limited reduction in impurity content in the final product, while the fluorine-compounds are almost completely dissolved during the acid leaching step.

The patent is intended to cover all possible variations and adjustments which may appear obvious for a person skilled in the art after reading this specification.

TABLE 3
Elemental composition (in wt %) of the pot fumes sample as received, of the sample after the acidification and
heat treatment step, and of the purified pot fumes produced:

| | weight | Al | O | C | F | Na | S | Ca | K | Fe | Si | P | Ni | V | Pb | Ti | Ga | Zn |
|---|---|---|---|---|---|---|---|---|---|---|---|---|---|---|---|---|---|---|
| | (g) | (%) | (%) | (%) | (%) | (%) | (%) | (%) | (%) | (%) | (%) | (%) | (%) | (%) | (%) | (%) | (%) | (%) |
| pot | 100 | 48 | 40 | 4 | 4.2 | 2.0 | 0.90 | 0.063 | 0.028 | 0.30 | 0.07 | 0.009 | 0.014 | 0.010 | 0.014 | 0.011 | 0.036 | 0.005 |
| fumes as | | | | | | | | | | | | | | | | | | |
| received | | | | | | | | | | | | | | | | | | |
| after | 103 | 52 | 42 | 0 | 1.6 | 1.1 | 3.3 | 0.068 | 0.018 | 0.27 | 0.07 | 0.009 | 0.014 | 0.010 | 0.013 | 0.013 | 0.032 | 0.005 |
| acidifi- | | | | | | | | | | | | | | | | | | |
| cation and | | | | | | | | | | | | | | | | | | |
| heat | | | | | | | | | | | | | | | | | | |
| treatment | | | | | | | | | | | | | | | | | | |
| after acid | 72 | 52 | 46 | 0 | 1.3 | 0.20 | 0.90 | 0.004 | 0.002 | 0.093 | 0.06 | 0.002 | 0.007 | 0.004 | 0.005 | 0.007 | 0.019 | 0.003 |
| leach and | | | | | | | | | | | | | | | | | | |
| water | | | | | | | | | | | | | | | | | | |
| wash | | | | | | | | | | | | | | | | | | |

TABLE 4
Elemental composition (in wt %) of the initial alumina fines sample as received, of the sample after the heat
treatment step, and of the purified alumina produced:

| | weight | Al | O | C | F | Na | S | Ca | K | Fe | Si | P | Ni | Cu | V | Pb | Ti | Ga | As |
|---|---|---|---|---|---|---|---|---|---|---|---|---|---|---|---|---|---|---|---|
| | (g) | (%) | (%) | (%) | (%) | (%) | (%) | (%) | (%) | (%) | (%) | (%) | (%) | (%) | (%) | (%) | (%) | (%) | (%) |
| alumina | 100 | 46 | 35 | 2 | 10.2 | 4.2 | 1.17 | 0.14 | 0.33 | 0.45 | 0.03 | 0.04 | 0.21 | 0.022 | 0.017 | 0.032 | 0.006 | 0.04 | 0.009 |
| fines as | | | | | | | | | | | | | | | | | | | |
| received | | | | | | | | | | | | | | | | | | | |
| after heat | 95 | 49 | 38 | 0 | 7.0 | 3.5 | 1.0 | 0.14 | 0.34 | 0.45 | 0.2 | 0.040 | 0.23 | 0.025 | 0.018 | 0.03 | 0.007 | 0.038 | 0.01 |
| treatment | | | | | | | | | | | | | | | | | | | |
| after acid | 62 | 51 | 46 | 0 | 0.4 | 0.20 | 0.65 | 0.04 | 0.06 | 0.50 | 0.19 | 0.021 | 0.25 | 0.023 | 0.017 | 0.027 | 0.007 | 0.046 | 0.007 |
| leach and | | | | | | | | | | | | | | | | | | | |
| water | | | | | | | | | | | | | | | | | | | |
| wash | | | | | | | | | | | | | | | | | | | |

1-18. (canceled)

19. A process for removal of impurities from secondary alumina fines or other aluminium and fluorine containing materials related to production of aluminium wherein the process comprises:
(a) acidification by adding an acid to the material to be purified;
(b) heating the acidified mixture with evolution of fluorine-containing gas;
(c) leaching the mixture in a solution of an acid;
(d) separating the solid and liquid for removal of the impurities in the liquid.

20. The process according to claim 19, wherein the gas evolved in step (a) and (b) is collected and guided to a dry scrubber, in order to recover the fluorine-compounds.

21. The process according to claim 19, wherein the acid is neat or aqueous.

22. The process according to claim 19, wherein the process is conducted in a batchwise or continuous mode.

23. The process according to claim 19, wherein between the steps (a) and (b) the material to be purified is mixed with the aqueous acid.

24. The process according to claim 19, wherein the acidified material is pre-dried before the heat treatment (b).

25. The process according to claim 19, wherein the material separated in step (d) is dried in a dryer.

26. The process according to claim 19, wherein the acid in step (a) is a strong acid.

27. The process according to claim 26, wherein the acid is sulphuric acid.

28. The process according to claim 19, wherein the molar ratio of H⁺ from the acid to F-content in the material is from 0.2 to 10.

29. The process according to claim 28, wherein the molar ratio is from 0.4 to 4.

30. The process according to claim 29, wherein the molar ratio is from 0.6 to 2.

31. The process according to claim 19, wherein the material before the acid leaching step is crushed in a crusher.

32. The process according to claim 25, wherein the solids before the drying step are washed in order to remove residual acid.

33. The process according to claim 32, wherein the washing liquor is water, lower alcohol or an alkali solution.

34. The process according to claim 33, wherein the washing liquor is methanol, ethanol or ammonia.

35. The process according to claim 19, wherein the volume of acid or aqueous acid in step (a) in total is from 10 to 1000 ml per 100 g alumina.

36. The process according to claim 35, wherein the volume of acid or aqueous acid is from 20 to 200 ml per 100 g alumina.

37. The process according to claim 36, wherein the volume of acid or aqueous acid is from 30 to 100 ml per 100 g alumina.

38. The process according to claim 19, wherein the residence time in the heat treatment is at least 2 minutes.

39. The process according to claim 38, wherein the residence time in the heat treatment is at least 5 minutes

30. The process according to claim 39, wherein the residence time in the heat treatment is at least 10 minutes.

41. The process according to claim 19, wherein the temperature in the heat treatment is from 100 to 1000° C.

42. The process according to claim 41, wherein the temperature in the heat treatment is from 300 to 800° C.

43. The process according to claim 42, wherein the temperature in the heat treatment is from 400 to 700° C.

44. The process according to claim 19, wherein the residence time in the acid leaching step is at least 5 minutes.

45. The process according to claim 44, wherein the residence time in the acid leaching step is at least 15 minutes.

46. The process according to claim 45, wherein the residence time in the acid leaching step is at least 30 minutes.

47. The process according to claim 19, wherein the residence time in the washing step for removal of residual acid is at least 2 minutes.

48. The process according to claim 47, wherein the residence time in the washing step is at least 5 minutes.

49. The process according to claim 48, wherein the residence time in the washing step is at least 10 minutes.

50. The process according to claim 19, wherein the temperature in the acid leach and washing step for removal of residual acid is in the range 20-150° C.

51. The process according to claim 50, wherein the temperature in the acid leach and washing step for removal of residual acid is in the range 60-95° C.
